(19) United States
(12) Patent Application Publication
(10) Pub. No.: US 2010/0304342 A1
(43) Pub. Date: Dec. 2, 2010

(54) Interactive Language Education System and Method

(75) Inventor: Julie R. Zilber, Vancouver (CA)

Correspondence Address: FASKEN MARTINEAU DUMOULIN LLP, 2900 - 550 Burrard Street, VANCOUVER, BC, V6C 0A3, CA

(73) Assignee: LINGUACOMM ENTERPRISES INC., Vancouver, BC (CA)

(21) Appl. No.: 12/095,724

(22) PCT Filed: Nov. 30, 2006
(86) PCT No.: PCT/CA2006/001974

§ 371 Date: Aug. 13, 2010

Related U.S. Application Data
(60) Provisional application No. 60/740,660, filed on Nov. 30, 2005.

(51) Int. Cl. G09B 19/06; G09B 5/00

(52) U.S. Cl. 434/157; 434/169

(57) ABSTRACT

An interactive system for improving conversational listening and speaking skills in a target language through interaction between personal communications devices (for example, mobile telephones using cellular or other wireless networks, telephones using PSTN lines, VOIP-enabled communications devices, smart phones, voice-enabled PDAs) and an automated system that provides oral/aural instruction and practice in vocabulary, pronunciation and grammar/syntax, engages the learner in simulated conversations, and provides personalized feedback and suggestions for further practice based on an analysis of the type and frequency of specific pronunciation and grammatical/syntactical errors.

This application claims the benefit of U.S. provisional patent application No. 60/740,660 filed Nov. 30, 2005, which is hereby incorporated by reference.

### FIELD OF THE INVENTION

This invention relates to systems and methods of teaching languages, and more particularly to such systems and methods using automated systems.

### BACKGROUND

There are over a billion people in the world who wish to learn to speak English as a second or foreign language, and an equivalent number of people who wish to learn to speak other languages as second or foreign languages. There are also over 1.5 billion cell phone users worldwide, a number that is expected to approach or exceed 2 billion in the next two years.

The ability to converse comfortably in a language depends on two skills: speaking and listening. Whether people are learning a language for business, for the purpose of immigration, for tourism, to attend academic institutions that use that language for instruction, or simply to be able to converse with native-speaking guests, the majority of second language learners lack the skills and confidence to communicate effectively in the second language. In many cases, in their country of origin, schools instruct students in grammar, reading and writing in the second language, but provide little or no practice in speaking or listening to native speakers. Where oral instruction is provided, the teachers are most often not native speakers, resulting in: the spoken language learned in these settings is often incomprehensible to native speakers; and a student learns to understand heavily accented speech but is unable to listen to and understand native speakers. Even when native speakers provide the instruction in the second language, there is a tendency for these instructors to (a) unconsciously over-enunciate, i.e. to speak more clearly and slowly than is normal for native speakers; and (b) to become accustomed to pronunciation and grammatical/syntactical errors to the extent that the teacher may no longer be sure whether these are errors at all. Furthermore, it is rare in a classroom setting for an individual student to get more than a few minutes of oral practice, and, of course, many people who need or want to learn the language are unable to attend language classes due to work, family and other commitments.

Few people have a personal tutor who can be by their side whenever needed to assist in language instruction. Not everyone can attend conversational classes every day. Most people do not have private 24-hour access to a desktop computer with a microphone and speakers. So, while speaking and listening are key to learning to speak a language, few people actually have the opportunity to engage in regular, realistic conversational practice with a native speaker who can detect and correct their pronunciation and grammatical/syntactical errors.

The following methods of delivering conversational language learning currently exist: books, tapes/audio CDs, videos, CD-ROM/DVD-ROM, web sites, and face-to-face instruction. To provide an effective learning experience, such instruction methods should have the following features:

Listen: The delivery method allows the learner to listen to native speakers.
Replay: The delivery method provides instant replay of the speech model upon the learner's request.
Speak: The delivery method responds to the learner's spoken input.
Responsive Dialogues: The delivery method allows the learner to participate in English conversations with native speakers, wherein the conversational responses of the system changes based on what the learner says.
Record and Playback: The delivery method records what the learner says and allows the learner to listen to what he or she said.
Personalized Feedback: The delivery method analyzes the learner's grammar and pronunciation and provides feedback on specific problem areas with suggestions for further practice.
Anytime, Anywhere: The delivery method accompanies the learner wherever he or she goes and is conducive to oral practice in public locations.
Easy to Use: The delivery method uses technology with which the learner is comfortable and familiar. The delivery method uses technology that is readily available to the learner.
Inexpensive to Use: The delivery method is affordable, even to learners with limited financial resources.
Updatable Content: The delivery method allows the learner to access different content over time.

The preferred alternatives in the prior art are:

Tapes/Audio CDs: Tapes and audio CDs allow learners to listen to recordings of native speakers. Learners can listen to the recordings and repeat what they hear, but they do not receive feedback on their pronunciation, grammar or syntax. To use these products the learner needs a tape player or CD player. Except in a formal language lab setting with a much more complicated technical environment, there is no mechanism for recording and playing back the learner's speech. These products do not respond to or provide any feedback on learner performance. A manual “rewind and search” is required to replay a section of the recorded model. If the learner wishes to practice speaking aloud, the learner will generally use these products in a private setting. The content of these products is fixed, and in order to obtain new content, the learner must obtain a new tape or CD.

CD-ROM/DVD-ROMs: CD-ROMs and DVD-ROMs allow learners to listen to recordings of native speakers. Learners can listen to the recordings and repeat what they hear. In some instances, the system records the learner's speech and allows it to be played back. In some instances, the learner can read aloud one of the roles in a pre-set dialogue. The dialogue is pre-set, in that the learner input must match the script precisely, and the next line of the dialogue is always the same. In these instances, if the waveform produced by the learner is a close match to the waveform produced by the model, the dialogue proceeds, otherwise, the dialogue does not proceed. When feedback is provided to the learner on his or her performance, it generally takes one of two forms: (a) display of a waveform that the learner can visually compare with a model waveform; and/or (b) a score or performance measure indicating how close the waveform produced by the learner is to the model waveform. Learners are not told what their errors are or provided with feedback and guidance on specific pronunciation errors or oral grammar or syntax errors. These products rely on visual (text and graphical) user interface components. To use these products learners need a computer with a CD-ROM or DVD-ROM drive, a microphone, and speakers or headphones. These products are generally used in private settings. The content of these products is fixed, and in order to obtain new content, the learner must obtain a new CD-ROM or DVD-ROM.

Web sites: Web sites sometimes allow learners to listen to recordings of native speakers. Learners may listen to the recordings and repeat what they hear. In some instances, the system records the learner's speech and allows it to be played back. If feedback is provided on the learner's pronunciation it generally takes one of two forms: (a) display of a waveform that the learner can visually compare with a model waveform; or (b) a score or performance measure indicating how close the waveform produced by the learner is to the model waveform. Learners are not told what their errors are, and are not provided with feedback and guidance on specific pronunciation or oral grammar or syntax errors. These web sites rely on visual (text and graphical) user interface components and are generally used in private settings. To use the web sites learners need a computer with an Internet connection, a microphone, and speakers or headphones.

### SUMMARY OF THE INVENTION

A method is provided for language instruction and automated conversational (oral/aural) language practice to users of personal communications devices (for example, mobile telephones using cellular or other wireless networks, telephones using PSTN lines, VOW-enabled communications devices, smart phones, and voice-enabled PDAs), that provides analysis of and feedback on specific pronunciation, grammar and syntax errors common to speakers of a particular first language group.

The method and system according to the invention delivers, via a personal communication device, an engaging simulation environment that can be used anytime and anywhere to gain language conversational skills. The method and system according to the invention allows language learners to practice speaking and listening to “virtual native speakers” of the targeted language wherever and whenever the learner chooses. The system and method according to the invention allows the learner to engage in “free” conversations on specific topics with “virtual native speakers”, and changes its responses based on what the learner says. The system uses a virtual “coach” to prepare the learner to engage in specific conversational topics, and allows the leaner to engage in realistic simulated conversations in which the system responds intelligently to learner input. The system and method analyzes the learners' spoken responses and provides personalized feedback, instruction and recommendations for further practice on specific pronunciation, grammatical and syntactical problems.

The system and method according to the invention provides several advantages over the prior art. It allows learners to use the system anytime, anywhere via a personal communication device. No special equipment is required, as the method can be used on common mobile phones or PSTN lines (therefore, there is no requirement for computer, Internet connection, microphone, or speakers).

The system provides access to an updatable body of content without requiring wired Internet connections or the acquisition of physical media such as CD-ROMs. The system also provides a natural environment for speaking and listening (as speaking and listening is what phones are designed for). The embarrassment often associated with oral practice in public is eliminated because it appears the user is simply engaged in a telephone conversation.

The system and method are easy to use by learners as familiar voice and phone interface requires no special technical expertise on the part of the learner. The system and method provides personalized coaching in vocabulary, grammar, syntax, idiom and comprehension to prepare the learner to engage in realistic simulated conversations, allows the learner to engage in realistic simulated conversations with “native speakers”, and provides intelligent responses to learner input.

The system and method detects pronunciation and grammatical/syntactical errors common to specific first language groups and gives personalized feedback, instruction and suggestions to the learner for further practice. It allows different learning paths (sequential, by level, by topic, by pronunciation or grammatical/syntactical issue) to be selected by the learner.

The system and method allows recording and playback of learner speech, allows instant replay of speech models upon learner request, and allows different levels of “intolerance” to be specified based on the learner's ability (e.g., at higher levels, the system can become increasingly intolerant of mistakes on the part of the learner).

The system tracks learner progress, and can automatically resume where the learner left off previously. Learners can easily jump to different sections of a lesson, and the lessons are preferably designed in short segments to support on-demand nature of mobile interactions.

The method according to the invention further provides a process by which developers of a lesson for use with the system can quickly organize and implement the content used to create such lesson.

A method of teaching a target language to a leaner having a personal communications device is provided, including: (a) the learner establishing voice communication with an automated speech response system; (b) the learner selecting a language lesson using the personal communications device; (c) the learner engaging in the language lesson by interacting with an automated speech recognition system using the personal communications device; and (d) providing feedback to the learner using predetermined statements based on errors made by the learner during said lesson.

The method may include providing the learner an opportunity to participate in a supplementary lesson. Utterances spoken by the learner throughout the lesson may be recorded. These utterances are compared to a grammar including common errors of speakers of a first language associated with the learner when using the target language. A log may be generated for the learner, and presented to a teacher of the learner.

The lesson may be a lesson in vocabulary, grammar or pronunciation. The lesson may be an interactive conversation with the speech recognition system.

A method of teaching a target language to a leaner having a personal communications device is provided, including: (a) the learner establishing voice communication with an automated speech response system; (b) the learner selecting a language lesson using the personal communications device; (c) the learner engaging in the language lesson by interacting with an automated speech recognition system using the personal communications device; and (d) providing feedback to the learner using predetermined statements based on correct responses made by the learner during the lesson.

An interactive language education system is provided, including: (a) a telephone gateway for receiving a telephone call from a learner of a target language via a personal communications device; (b) a voice recognition system for receiving utterances from the learner, the voice recognition system having a grammar, the grammar including a phrase commonly mispronounced in the target language, by a speaker of a first language associated with the learner, wherein the grammar can identify the mispronounced phrase and (c) means to communicate a correct pronunciation of the phrase to the learner via the personal communications device.

A grammar for a voice recognition system is provided, including: (a) a plurality of correct pronunciations of words in a first language; (b) for a selection of the plurality of correct pronunciations, a plurality of incorrect pronunciations of the selection of words; wherein the grammar distinguishes between the correct and incorrect pronunciations of the selection of words. The incorrect pronunciations may be common mispronunciations of the selected words by speakers of a second language.

A voice recognition system is provided, including a grammar of a first language, the grammar including grammatical mispronunciations common to speakers of a second language learning the first language, wherein the grammar can identify the grammatical mispronunciations made by a learner.

A method of creating a language lesson is provided, including the steps of: (a) providing a topic of the lesson; (b) identifying a grammar issue to be addressed in the lesson; (c) providing an introductory explanation of the grammar issue; (e) providing a phrase relevant to the topic that illustrates the grammar issue; (f) providing instructions for an exercise in which a learner will change a sentence using an appropriate grammatical form; (g) providing an example illustrating how the exercise is done; (h) describing a plurality of errors the learner may make in attempting the exercise and providing a feedback statement for each error; and (i) providing a sentence for the learner to change using the appropriate grammatical form.

The method may further include (j) identifying a pronunciation issue to be addressed in the lesson; (k). providing an example of the pronunciation issue; (l) identifying a word, and providing a common mispronunciation of a target phoneme in the word by a particular first language group; (m) providing a phrase that includes the word; (n) providing a second feedback statement for mispronunciation of the word; and (o) providing instructions on how to pronounce the word; providing a sample dialogue including the word.

The method may further include: (q) providing a context specific vocabulary in the sample dialogue, and an explanation of its meaning in the dialogue; a sentence from the dialogue that incorporates the vocabulary; a restatement of the sentence from the dialogue that replaces the context specific vocabulary with another word or words that retain an original meaning associated with the vocabulary; and a restatement of the sentence from the dialogue that replaces the vocabulary with another word or words that changes the meaning of the sentence.

### DESCRIPTION OF THE FIGURES

FIG. 1 is a flow chart showing the method of teaching a language according to the invention; and

FIG. 2 is a block diagram showing the system for teaching a language according to the invention.

### DESCRIPTION OF THE INVENTION

The system according to the invention is an automated system allowing learners to improve their conversational speaking and listening skills in a foreign language. The system combines voice recognition technology with grammar and pronunciation analysis software on the server-side to create a simulated environment that allows fast, realistic, and context-sensitive responses and personalized feedback to be provided to a learner using a personal communications device (for example, mobile telephone using cellular or other wireless networks, telephone using PSTN lines, VOW-enabled communications device, smart phone, or voice-enabled PDA).

The system marries proven principles of language learning and innovative content design with phone and server-side technology to create a compelling, meaningful, and pedagogically sound, mobile environment for spoken language learning.

The system provides a structured learning process, including a series of conversational lessons. The user interacts with the system primarily by speaking and listening. The content is provided in short segments, supporting the on-demand nature of mobile learning. Each lesson focuses on a particular pronunciation issue, grammaticaUsyntactical issue, and/or topic of conversation. Each conversational topic is addressed at multiple levels of difficulty. The learner can choose to proceed through the lessons sequentially (from beginning to end), to select a specific lesson, to focus on a particular pronunciation or grammatical/syntactical problem, or to focus on a particular conversational topic. The systems acts as a coach, prepping the learner for specific conversational situations, and listening for particular pronunciation and grammatical/syntactical problems common to speakers of a specific first language group. Instructional content is provided in both the target language and the learner's first language. The invention provides discrete and cumulative feedback on learner performance, using a statistical model to provide customized feedback based on the frequency of different types of errors. Supplementary pronunciation and grammaticaUsyntactical practice units are available for each lesson, and the system may direct the learner to these units or back to the preparatory modules when particular problems are detected. The system includes a user registration and tracking module, and a content management module that allows the addition of new content and the definition of custom lexicons and grammars by non-technical subject matter experts. The system further includes a customized methodology for the design and codification of lessons.

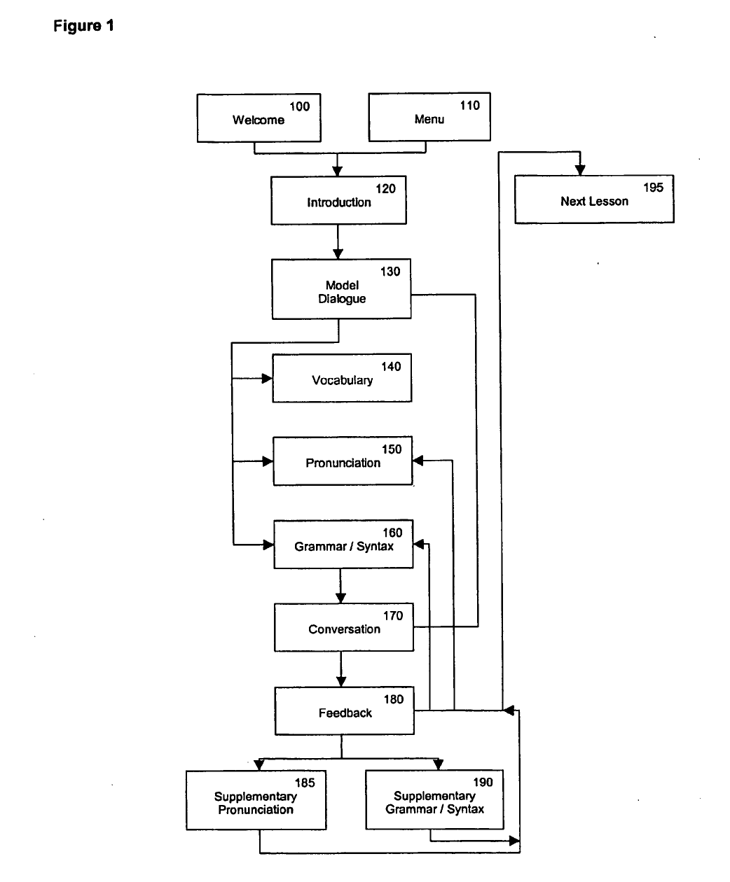

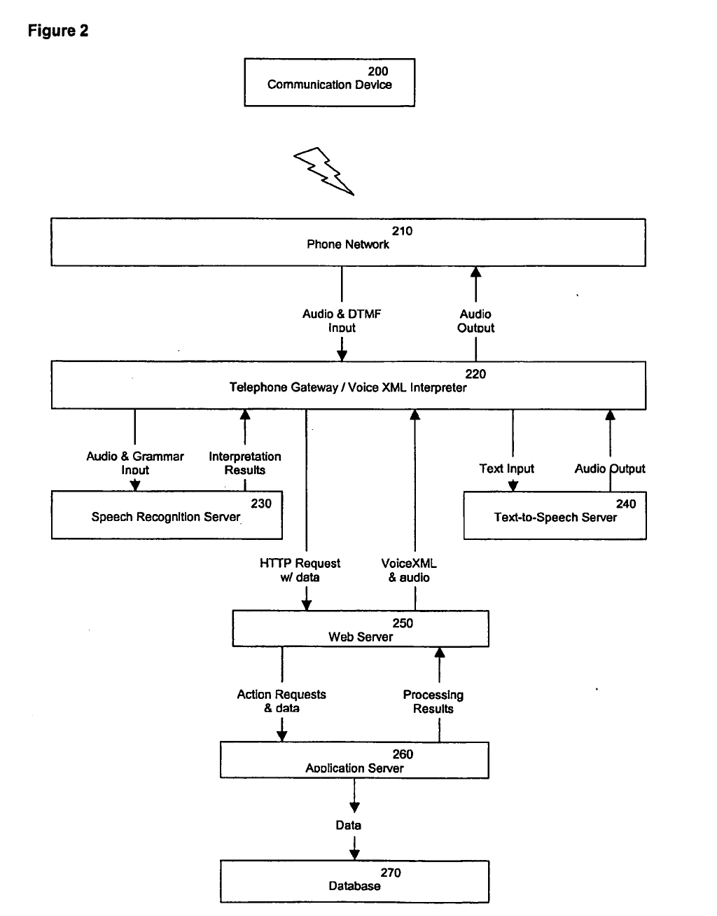

The following description of the invention refers to FIGS. 1 and 2. FIG. 1 displays the process by which a learner uses the system according to the invention. In step 100, after dialing the system, the learner is greeted with a welcome message. This welcome message may be tailored to the learner, who can be identified using voice recognition, identifying the learner's phone number, personal identification number (PIN) or other means.

The learner can then make selections (using the keypad or spoken commands) from an offered menu (step 110). From the menu the learner can elect to progress via conversational topic or competency level. On identification of the learner the system, by default, will automatically resume at point last session was discontinued.

The learner then receives an introduction to the conversational topic, and pronunciation and grammar/syntax issues dealt within the selected lesson (step 120). The learner listens to a brief dialogue incorporating the conversational topic, and pronunciation and grammar/syntax issues dealt with in the current lesson (step 130).

The learner then receives instruction on specific vocabulary, pronunciation, or grammar/syntax issues, and then receives evaluation and feedback on pronunciation, grammar, & comprehension. The learner can then playback his/her utterances and compare them with model utterances. These are done in steps 140, 150, and 160 for vocabulary, pronunciation and grammar/syntax lessons, respectively.

The learner then engages in simulated conversation on a specified topic (step 170). The system responds with appropriate and intelligent conversational responses or provides hints to the learner if appropriate.

In step 180, the learner receives coaching on specific pronunciation or grammar/syntax issues identified during the conversation. The feedback may include playback of the learner's speech and comparison with native speakers, explanation of identified pronunciation or grammar/syntax errors, instruction on proper usage, and a direction to a review of the earlier model dialogue, or preparation and drill section, or to proceed through a supplementary practice on a specific pronunciation or grammar/syntax issue wherein the learner receives more detailed instruction on identified problems with pronunciation or grammar/syntax (steps 185 and 190). A statistical analysis of the nature and frequency of specific errors determines appropriate coaching response offered by the system.

The following describes the interaction between the learner and an embodiment of the system, with reference to FIG. 1.

The learner accesses a conversational language course by dialling a number on his/her personal communications device (in this example a mobile telephone is assumed). A brief welcome is played, and the learner is given the option of receiving instructions in the language being taught, known as the “target language” (English, in this example) or the learner's first language. At any time thereafter, the learner can switch between receiving instructions in the target language (e.g. English) or the learner's first language. The mobile device ID is detected, and the learner is asked to enter a Personal Identification Number (PIN). If the learner does not have a PIN, he/she is directed to a registration system. If the learner enters a valid PIN, the learner is welcomed (step 100) back to the course and given the option of continuing from the point at which the learner stopped last or of choosing a lesson from the menu.

Throughout the lesson, the manner in which the learner is presented with and selects options, will depend on the capabilities of the learner's personal communication device and network used to access the system. Depending on the capabilities of the learner's personal communication device and telephone network, options are presented aurally (using an automated speech response (ASR) system) or visually (using the digital display on a mobile telephone). The learner selects the desired option either by providing a spoken response to the ASR system or by pressing the specified keys (for example, on a mobile telephone).

Spoken output from the system is either pre-recorded audio segments or is generated by a text-to-speech engine.

From the Menu (step 110) the learner can select a lesson based on Conversational Topic, Level, Pronunciation Issue, or Grammatical Issue. The learner can also access help on how to use the system from the Menu.

Each lesson begins with an Introduction (step 120). This audio introduction is spoken in the voice of the “Coach”, the system's spoken “personality” who provides instruction and feedback to the learner. The learner has the option of hearing instructions in either in the learner's first language or in the target language. In the introduction, the Coach explains the purpose of the lesson: what conversational topic, pronunciation issue, and/or grammatical/syntactical issue are addressed in the lesson.

Following the Introduction, the learner is presented with a Model Dialogue (step 130). In the Model Dialogue the learner hears a short, idiomatic, and culturally appropriate dialogue that incorporates the conversational topic, pronunciation issue and/or grammatical/syntactical issue that is the focus of the lesson. Each dialogue is made up of a series of exchanges between two or more characters. The learner has the option of replaying this dialogue as many times as desired. The dialogue may be a pre-recorded audio segment or be generated by a text-to-speech engine.

After listening to the Model Dialogue, the learner can engage in any or all of the following three preparatory modules:

Vocabulary Module (step 140): The learner can listen to and obtain contextual definitions of words and phrases used in the dialogue that may pose difficulties because, for example, they are idiomatic or unusual uses. Examples of such common phrases in English are “I′m afraid not” (meaning “I′m sorry to have to say no”), and “to hold you up” (meaning “to delay you”). At the learner's choice, definitions and instructions may be provided either in the learner's first language or in the target language. The learner can listen to a model of each vocabulary item and its definition as many times as desired. The learner can practice saying the vocabulary terms, compare his/her pronunciation with that of the model, and receive feedback on his/her pronunciation. The learner can engage in a comprehension exercise testing his/her understanding of the words and phrases in this module. In the exercise, the learner hears pre-recorded statements that incorporate words or phrases from this module. The Coach then asks the learner to choose the correct meaning of each statement from among several options. The statements may be pre-recorded audio segments or be generated by a text-to-speech engine.

Pronunciation Module (step 150): The Coach describes the pronunciation issue that is the focus of this module and explains why it is a problem for members of the learner's first language group. The learner can listen to words or phrases used in the dialogue that contain the pronunciation issue that is the subject of the lesson. An example of such a pronunciation issue would be the differentiation between the English /l/ and /r/ sounds for speakers of Cantonese as a first language. Learners can listen to and repeat model words or phrases included in this module, and can listen to recordings of their pronunciation. The learner can practice saying the vocabulary terms, compare his/her pronunciation with that of the model, and receive feedback on his/her pronunciation. The learner can listen to and repeat the words and phrases in this module as many times as desired. Learners can participate in an aural comprehension exercise. In this exercise, the learner hears a statement incorporating the words or phrases that are used in this module. The coach then asks the learner to choose the correct meaning of each statement from two options, where each option represents a different meaning that could be derived depending on whether the learner's ear was able to distinguish the correct pronunciation. For example: Did the woman say she was going to put the papers in a folder or that she was going to burn the papers? (“I′m going to put the papers in the file” versus “I′m going to put the papers in the fire?”).

Grammar/Syntax Module (step 160): The Coach describes the grammar/syntax issue that is the focus of this module and explains why it is a problem for members of the learner's first language group. The learner can listen to model statements incorporating the grammar/syntax issue that is the subject of this lesson. The learner can replay these statements as many times as desired. The learner can practice saying the statements, compare what he/she said to the model statements, compare his/her pronunciation with that of the model statements, and receive feedback on any errors made in reproducing the model statements. The learner is then asked to create statements that use the correct grammatical/syntactical form being taught in this module based on a model. For example: Change the following statement from a command to a polite request using “would you” or “could you.” Command: “Wait five minutes.” Polite request: “Could you wait five minutes?” The learner speaks his/her response. The Coach provides feedback on the learner's response.

When the learner feels he/she is ready, the learner can begin the Conversation (step 170). In the Conversation, the Coach describes a scenario in which the learner will engage in a conversation with a “virtual native speaker” (for example, “You have an appointment for a job interview at 11 o'clock with Ms. Blake. You will be greeted by the receptionist. Listen and respond.”). The system, acting as the other character, using pre-recorded audio or text-to-speech technology, initiates the conversation. The learner responds orally to what he/she hears. Based on the learner's response, the system may respond by: (a) using one of several possible appropriate pieces of dialogue to continue the conversation; (b) remaining “in character” and asking the learner to repeat his/her response; (c) providing a hint as to what the learner might say; or (d) replaying the appropriate exchange from the Conversation.

During the Conversation, the system compares the language produced by the learner to a custom lexicon of flagged words and phrases and variations on those words and phrases commonly produced by speakers of the learner's first language group. Each variation represents a specific pronunciation or grammatical/syntactical error. Each variation made by the learner is recorded as a database entry.

At the end of the Conversation the learner receives Feedback (step 180) from the Coach. If there are no errors, the learner will hear a message in which the Coach congratulates the learner on his/her performance and suggests that he/she continue to the Next Lesson (step 195). If the learner used the pronunciation and grammar/syntax that is the subject of the lesson correctly in most instances but made a small number of errors, the Coach will play back a recording of the statement in which an error was detected and an example of what a native speaker would have said in that instance. The Coach will provide a brief reminder about the pronunciation or grammatical/syntactical issue (the methodology may be constructed on the premise that a learner who deals correctly with a pronunciation or grammatical/syntactical issue most of the time understands the “rule” and only needs to be reminded to “pay attention”). If the learner frequently or consistently made a pronunciation or grammatical/syntactical error throughout the conversation, the Coach will explain to the learner that he/she is having a problem with a specific pronunciation or grammatical/syntactical issue (for example, “I noticed that you were using singular verbs with plural nouns”) and will explain why this is a problem for people from the learner's first language group. Recordings of the learner's statements containing errors may be played back and compared with statements produced by native speakers. Depending on the frequency of each type of error, the Coach will then: (a) suggest that the learner review the Pronunciation (step 150) or Grammar/Syntax (step 160) modules of the lesson; (b) do the Supplementary Pronunciation (step 185) or Supplementary Grammar/Syntax (step 190) modules to learn more about the identified pronunciation or grammatical/syntactical issue; or (c) try an easier lesson. The learner may proceed as suggested by the “Coach”, or may repeat the Conversation (step 170) again.

If the learner is referred to the Supplementary Pronunciation (step 185) module, the learner receives more detailed instruction on the specific pronunciation issue that is the focus of the lesson (for example, how to position and move the lips, tongue and jaw to produce the English In sound). The learner will be given the opportunity to practice words and phrases incorporating the specific pronunciation issue, and will receive feedback on his/her performance. The system will record and analyse the frequency of correct and incorrect responses. When the learner's performance matches the performance expected at the learner's current level, the Coach will suggest that the learner return to the main lesson.

If the learner is referred to the Supplementary Grammar/Syntax (step 185) module, the learner will receive more detailed instruction on the specific grammar/syntax issue that is the focus of the lesson (for example using plural verbs with plural nouns). The learner will be given the opportunity to practice producing phrases incorporating the specific granunar/syntax issue and will receive feedback on his/her performance. The system will record and analyse the frequency of correct and incorrect usage. When the learner's performance matches the performance expected at the learner's current level, the Coach will suggest that the learner return to the main lesson.

### Global Commands

At any time, the learner may switch between receiving instructions in his/her first language or the target language by pressing a key, for example the “*” key. The learner can also make. certain requests by speaking key commands (or alternatively pressing a key associated with such commands). These include: “Menu”, “Help”, “Skip, “Continue”, “Repeat”, and “Goodbye”. “Menu” returns the learner to the Menu (step 110) described above. “Help” provides context-sensitive help to the learner based on the activity in which the learner is then engaged. “Skip” allows the learner to move from one example or statement to the next within a module. “Continue” allows the learner to move from one module to the next within a lesson, or from the end of one lesson to the beginning of the next lesson. “Repeat” allows the user to replay any portion of a module (e.g., vocabulary definition or exercise, pronunciation example or exercise, grammar/syntax example or exercise, etc.). “Goodbye” terminates the session. In a preferred embodiment of the invention, the system will disconnect automatically after a fixed period of time without a response from the learner.

FIG. 2 illustrates an embodiment of a technical implementation according to the invention. The learner's personal communications device 200 (for example, mobile telephone using cellular or other wireless network, telephone using PSTN lines, VOID-enabled communications device, smart phone, or voice-enabled PDA), sends audio and DTMF input via telephone network 210 (cellular phone network or POTS) to telephone gatewayNoiceXML interpreter 220, which resides on a computer having, preferably, a processor, RAM, storage media, network card(s) and telephony card(s). Telephone gatewayNoiceXML interpreter 220 sends audio input and the appropriate grammar to the speech recognition server 230. Speech recognition server 230 interprets the audio input, converts the audio to text, and returns the text results to telephone gatewayNoiceXML interpreter 220. Based on the results, the telephone gatewayNoiceXML Interpreter 220 submits an HTTP request containing the relevant data to web server 250. On receipt of the HTTP request, web server 250 transmits a request to application server 260 to do one of the following actions (as indicated in the HTTP request): create new user; verify user; retrieve user status; retrieve instructional content; record learner performance; analyze learner performance or provide feedback.

During the Vocabulary, Pronunciation, and Grammar/Syntax preparation and drill (steps 140, 150 and 160 respectively), supplementary practice for pronunciation and grammar/syntax (steps 185 and 190 respectively), and Conversation (step 170), application server 260 compares the language produced by the learner to a custom grammar (lexicon) of flagged words and phrases and variations on those words and phrases commonly produced by speakers of the learner's first language group. Each variation represents a specific pronunciation or grammatical/syntactical error. When a flagged word or variation is identified by the system, the system will retrieve the appropriate coaching content from database 270 and deliver it to web server 250, as described below.

During the preparation and drill exercises for vocabulary, pronunciation and granunar/syntax (steps 140, 150 and 160, respectively), each time the learner's response matches a flagged word or phrase, he/she will receive a coaching response indicating that the response is correct. Each time the learner produces a variation representing a specific pronunciation or grammatical/syntactical error, he/she will receive a coaching response that may include: repetition of the question, repetition of the instructions and the question, detailed instructions on how to do the exercise, recommendation to review the lesson, recommendation to do the supplementary practice (steps 185 or 190 as appropriate), or recommendation to try a simpler lesson.

During the supplementary practice for pronunciation or grammar/syntax exercises (steps 185, 190, respectively), each time the learner's response matches a flagged word or phrase, he/she will receive a coaching response indicating that the response is correct. Each time the learner produces a variation representing a specific pronunciation or grammatical/syntactical error, he/she will receive a coaching response that may include: repetition of the question, repetition of the instructions and the question, detailed instructions on how to do the exercise, detailed instructions on how to produce particular sounds or on the use of particular grammatical/syntactical constructions, recommendation to review the lesson, or recommendation to try a simpler lesson.

During the Conversation (step 170), the system determines if each piece of user input (also known as utterances) matches one of several anticipated inputs or is unrecognized. In each instance, the system plays an appropriate response, moving the conversation forward to its logical conclusion. Different inputs from the user will trigger different responses being played by the system. At the end of the conversation, the system offers the learner the option of trying the conversation again. During the conversation each incorrect variation of an anticipated input spoken by the learner is recorded. At the end of the conversation, application server 260 calculates the frequency of errors of each type produced by the learner during the dialogue. Based on the number of errors of each type produced by the learner during the dialogue, the system will retrieve the appropriate coaching content from database 270 and deliver it to web server 250. Coaching responses may include: (a) congratulations and a recommendation to proceed to the next lesson; (b) playback of statements containing errors and model statements for comparison, and a brief reminder of the relevant pronunciation or grammar/syntax rule; or (c) explanation to the learner that he/she is having a problem with a specific pronunciation or grammatical/syntactical issue and an explanation as to why this is a problem for people from the learner's first language group. Recordings of the learner's statements containing errors may be played back and compared with statements produced by native speakers of the target language. Depending on the frequency of each type of error, the coach will then (i) suggest that the learner review the pronunciation (step 150) or grammar/syntax (step 160) modules of this lesson or (ii) do the supplementary pronunciation (step 185) or supplementary grammar/syntax (step 190) modules to learn more about the identified pronunciation or grammatical/syntactical issues.

Web server 250 delivers responses to telephone gatewayNoiceXML interpreter 220 in the form of VoiceXML together with any pre-recorded audio. If system responses are being generated using a text-to-speech engine, telephone gatewayNoiceXML interpreter 220 transmits the text to be translated to text-to-speech server 240. Text-to-speech server 240 generates audio output that is sent back to telephone gatewayNoiceXML interpreter 220. Telephone gatewayNoiceXML interpreter 220 then delivers a spoken response that is delivered to the learner's personal communications device 200 via telephone network 210.

Telephone gatewayNoiceXML interpreter 220, speech recognition server 230, text-to-speech server 240, web server 250, application server 260, and database 270 may all reside on one computer or may be distributed over multiple computers having processor(s), RAM, network card(s) and storage media.

The system according to the invention has additional features. For example, the system creates a log of each activity the learner undertakes and stores such log in database 270. Speech utterances (or inputs) made by the learner in each session are recorded in database 270. These logs and recordings can be used to generate: (a) reports for learners, in which the learner can review their progress and review their speech utterances; and (b) reports for teachers, in which the teacher can review the learner's progress and review the learner's speech utterances.

In an embodiment of the invention, the system detects which learners are using the system at any given time, and determines at what level and topic each learner is studying. This information is used to match similar learners with each other, and provide these matched learners the option of engaging in peer-to-peer real-time conversational practice using voice communication with each other, such as VoIP.

Furthermore, the system may provide the learner with the option of connecting to a live tutor using voice or VoIP, for example by speaking a key command such as “Tutor”. If the system connects a learner with a live tutor, the tutor receives a report indicating what activities the learner has undertaken and the learner's current topic and level.

In an alternative embodiment, the system according to the invention can also provide a range of visual content, depending on the capabilities of the user's personal communications device and network, including for example: (a) short animations illustrating how the tongue, lips and jaw move to produce certain phonemes; (b) short videos incorporating and dramatizing the sample dialogues; or (c) pictures or animations illustrating the vocabulary terms.

### Template for Lessons

The system, according to the invention, also provides a step-by-step process for generating lessons. These lessons can then be used as described above.

The first step is to identify a topic for the lesson. For example: “The Job Interview—Meeting the Receptionist”.

The second step is to identify a grammar issue to be addressed in the lesson. For example, “In this section we'll practice using definite and indefinite articles”.

The third step is to provide an introductory explanation of the grammar issue. For example “English has two types of articles: definite and indefinite. Definite articles are used when you are referring to a specific item. For example, “the cup of coffee” refers to a particular cup of coffee. Indefinite articles are used when you are referring to any member of a category of things. For example, “a cup of coffee” refers to any cup of coffee.”

The fourth step is to provide up to six phrases (not necessarily full sentences) that are relevant to the topic of the lesson that illustrate the grammar issue.

The fifth step is to provide instructions for an exercise in which the learner will change a sentence using the appropriate grammatical form. For example: “In the following sentences, replace the definite article “the” with the appropriate indefinite article “a”, “an” or “some””.

The sixth step is to provide an example illustrating how the exercise is to be done.

For example:
A sentence using the definite article “the”:
   “Would you like the cup of coffee?”
Now a sentence using the indefinite article “a”:
   “Would you like a cup of coffee?”]

The seventh step is to describe each possible error the learner may make in attempting the exercise. For each possible error, an appropriate feedback statement is provided.

For example:
Incorrect Response A:
   Repeats original sentence.
Feedback for Incorrect Response A:
   “It sounded as if you repeated the example. Let's try again. Listen to the example and then replace the definite article “the” with the appropriate indefinite article “a”, “an” or “some.””

In the eighth step, using the phrases identified in the fourth step, sentences are created that the learner will change using the appropriate grammatical form. For each sentence, the correct response is provided, as well as each anticipated incorrect variation. For each incorrect variation, the appropriate feedback option is indicated.

For Example:

| | | Feedback |
|---|---|---|
| | | Option |
| Original Sentence | Did you develop the application? | |
| Correct Response | Did you develop an application? | |
| Incorrect Response 1 | Repeats the original | A |
| Incorrect Response 2 | Did you develop an application? | B |
| . . . | | |
| Incorrect Response | N | N |

The ninth step is to identify a pronunciation issue to be addressed in this lesson, for example: “In this section we'll work on pronunciation of words that begin with the sound /r/ as in “right.””

The tenth step is to provide an example of the pronunciation issue. For example: “The word “Look” begins with the sound /l/ as in “Love”. “To look at” something means “to focus your eyes on” something. The word “Rook” contains the sound /r/ as in “Raymond”. The word “rook” is a noun meaning either a crow or one of the pieces in a chess game. “Look” and “Rook” sound similar but have very different meanings.”

The eleventh step is to identify a number of words, such as five or six words, that make sense in the context of the topic of the lesson that incorporate the pronunciation issue. For each word, a counterpart is provided that incorporates a common mispronunciation of the target phoneme by the particular first language group.

For example:
Word incorporating pronunciation issue: Right
Word incorporating common mispronunciation: Light

The twelfth step is to create five or six short phrases that make sense in a dialogue related to the topic of this lesson and that incorporate the vocabulary words listed in the previous table. The phrase is provided both using the word incorporating the pronunciation issue and using the word incorporating the common mispronunciation.

For example:
Correct phrase: You are right!
Phrase with incorrect pronunciation: You are light!

In the thirteenth step basic feedback is provided for incorrect pronunciation. For example: “It sounded as if you said “light” instead “right””.

In the fourteenth step, detailed feedback is provided on how to make the desired sound. For example: “To produce the /l/ sound at the beginning of a word, start with the tip of your tongue between your teeth, and slide the tip of your tongue back along the roof of your mouth as you make the sound.”

In the fifteenth step, a description is provided for a sample dialogue based on the topic of the lesson. For example: “In this sample dialogue you will hear an exchange between a receptionist and a job applicant.”

In the sixteenth step, a script is provided for a short dialogue or conversation (with approximately six exchanges) reflecting the topic of the job interview. In the dialogue, the phrases identified in the fourth step and the words identified in the eleventh step are incorporated. Idiomatic and context appropriate language is used in the dialogue, and the dialogue is written at the target learning level.

In the seventeenth step, examples of idiomatic or context specific vocabulary in the sample dialogue are identified that may be unfamiliar to the learner. For each word or phrase, the following are provided:
an explanation of its meaning in the context of the dialogue;
a sentence from the dialogue that incorporates that word or phrase;
a restatement of the sentence from the dialogue that replaces the word or phrase with another word or words that retain the original meaning; and
a restatement of the sentence from the dialogue that replaces the word or phrase with another word or words that change the meaning.

For example:

| | |
|---|---|
| Word or phrase | Fire away! |
| Explanation | In the dialogue, we can hear how “Fire |
| | away!” is used as an informal way to |
| | encourage the other person to proceed |
| Sentence from the dialogue | Fire away! |
| Restatement (same meaning) | Please proceed! |
| Restatement (different meaning) | Please shoot me! |

In the eighteenth step, a scenario for a “free” conversation based on the topic of the lesson is described. Any key information the leaner will be required to provide during the conversation is included. For example: “You are a job applicant. You have an appointment for an interview with Ms. Blake at 11 o'clock. You will be greeted by the receptionist. Listen to her greeting and respond.”

In the nineteenth step, opening statements are provided for the anticipated conversation.

| | | |
|---|---|---|
| Statement/question A | Type opening | Identify which response (B, C, D, E, |
| | statement/question. | F . . . X, should be provided) |
| Anticipated response | Provide list of possible responses | Identify which response (B, C, D, E, |
| type 1 | that are of anticipated response | F . . . X, should be provided) |
| | type 1. | |
| Anticipated response | Provide list of possible responses | Identify which response (B, C, D, E, |
| type 2 | that are of anticipated response | F . . . X, should be provided) |
| | type 2. | |
| Anticipated response | Provide list of possible responses | Identify which response (B, C, D, E, |
| type 3 | that are of anticipated response | F . . . X, should be provided) |
| | type 3. | |
| Anticipated response | Provide list of possible responses | Identify which response (B, C, D, E, |
| type 4 | that are of anticipated response | F . . . X, should be provided) |
| | type 4. | |
| No response | | Identify which response (B, C, D, E, |
| | | F . . . X, should be provided) |
| Incomprehensible | | Identify which response (B, C, D, E, |
| response | | F . . . X, should be provided) |

New tables are created for as many statements/questions as required.

The above process allows lesson creators to quickly and easily generate lessons for use with the system. In an embodiment of the invention, the above process is used within a computer-based content authoring system in which the lesson creator can script the lesson by filling in fields and selecting options, provide voice input to the system and create the appropriate grammar. When the lesson creator fills in a field, the system uses that information to populate the balance of the form to guide and assist the lesson creator in the lesson creation process. For example, in the seventh step, the lesson creator identifies the responses that should be provided to respond to possible mistakes (A, B, C . . . N) that a learner might make in a grammar exercise. As part of the eighth step, in specifying which response should be provided to each anticipated mistake, the lesson creator can select from a list of responses (for example, a dropdown menu or scrolling list) generated from the responses he/she specified in the seventh step.

While the system and method described above is a preferred embodiment of the invention, many variations are possible while staying within the spirit of the invention. For example, the process of preparing a lesson disclosed need not include all of the above steps, and may include more or less steps as preferred. Also the method described herein may be implemented as a computer program product, having computer readable code embodied therein, for execution by a processor within a computer. The method may also be provided in a computer readable memory or storage medium having recorded thereon statements and instructions for execution by a computer to carry out the method.

1. A method of teaching a target language to a learner leaner having a personal communications device, comprising:
(a) the learner establishing voice communication with an automated speech response system;
(b) the learner selecting a language lesson using the personal communications device;
(c) the learner engaging in said language lesson by interacting with an automated speech recognition system using the personal communications device; and
(d) providing feedback to the learner using predetermined statements based on errors made by the learner during said lesson.

2. The method of claim 1, further comprising: (e) providing the learner an opportunity to participate in a supplementary lesson.

3. The method of claim 2 wherein utterances spoken by the learner throughout said lesson are recorded.

4. The method of claim 3 wherein said utterances are compared to a grammar including common errors of speakers of a first language associated with the learner when using said target language.

5. The method of claim 4 wherein a log is generated for the learner.

6. The method of claim 5 wherein said log is presented to a teacher of the learner.

7. The method of claim 6 wherein said lesson is a lesson in vocabulary.

8. The method of claim 6 wherein said lesson is a lesson in grammar.

9. The method of claim 6 wherein said lesson is a lesson in pronunciation.

10. The method of claim 6 wherein said lesson is an interactive conversation with said speech recognition system.

11. A method of teaching a target language to a learner leaner having a personal communications device, comprising:
(a) the learner establishing voice communication with an automated speech response system;
(b) the learner selecting a language lesson using the personal communications device;
(c) the learner engaging in said language lesson by interacting with an automated speech recognition system using the personal communications device; and
(d) providing feedback to the learner using predetermined statements based on correct responses made by the learner during said lesson.

12. An interactive language education system, comprising:
(a) a telephone gateway for receiving a telephone call from a learner of a target language via a personal communications device;
(b) a voice recognition system for receiving utterances from said learner, said voice recognition system having a grammar, said grammar including a phrase commonly mispronounced in said target language, by a speaker of a first language associated with said learner, wherein said grammar can identify said mispronounced phrase; and
(c) means to communicate a correct pronunciation of said phrase to said learner via said personal communications device.

13. A grammar for a voice recognition system comprising:
(a) a plurality of correct pronunciations of words in a first language; and
(b) for a selection of said plurality of correct pronunciations, a plurality of incorrect pronunciations of said selection of words; wherein said grammar distinguishes between said correct and incorrect pronunciations of said selection of words.

14. The grammar of claim 13 wherein said incorrect pronunciations are common mispronunciations of said selected words by speakers of a second language.

15. A voice recognition system comprising a grammar of a first language, said grammar including grammatical mispronunciations common to speakers of a second language learning said first language, wherein said grammar can identify said grammatical mispronunciations made by said learner.

16. A method of creating a language lesson, comprising the steps of:
(a) providing a topic of the lesson;
(b) identifying a grammar issue to be addressed in the lesson;
(c) providing an introductory explanation of said grammar issue;
(e) providing a phrase relevant to said topic that illustrates said grammar issue;
(f) providing instructions for an exercise in which a learner will change a sentence using an appropriate grammatical form;
(g) providing an example illustrating how said exercise is completed;
(h) describing possible errors said learner may make in attempting said exercise and providing a feedback statement for each said error; and
(i) providing a sentence for said learner to change using said appropriate grammatical form.

17. The method of claim 16, further comprising:
(j) identifying a pronunciation issue to be addressed in the lesson;
(k). providing an example of said pronunciation issue;
(l) identifying a word, and providing a common mispronunciation of a target phoneme in said word by a particular first language group;
(m) providing a phrase that includes said word;
(n) providing a second feedback statement for mispronunciation of said word;
(o) providing instructions on how to pronounce said word; and
(p) providing a sample dialogue including said word.

18. The method of claim 17 further comprising:
(q) providing a context specific vocabulary in said sample dialogue, and an explanation of its meaning in said dialogue; a sentence from said dialogue that incorporates said vocabulary; a restatement of said sentence from said dialogue that replaces said context specific vocabulary with another word that retain an original meaning associated with said vocabulary; and a restatement of said sentence from said dialogue that replaces said vocabulary with another word or words that change the meaning of said sentence.
